(19) United States
(12) Patent Application Publication
(10) Pub. No.: US 2026/0063944 A1
(43) Pub. Date: Mar. 5, 2026

(54) DISPLAY PANEL HAVING NON-UNIFORM BLACK MATRIX

(71) Applicant: Varjo Technologies Oy, Helsinki (FI)

(72) Inventors: Matti Jakonen, Rusko (FI); Janne Lesonen, Helsinki (FI)

(73) Assignee: Varjo Technologies Oy, Helsinki (FI)

(21) Appl. No.: 18/824,247

(22) Filed: Sep. 4, 2024

(51) Int. Cl. G02F 1/1335

(52) U.S. Cl. CPC G02F 1/133512

(57) ABSTRACT

Disclosed is a display panel with an array of pixels, each pixel having at least three sub-pixels; and a black matrix having a plurality of black matrix components, each black matrix component being arranged to form a boundary between two corresponding sub-pixels; wherein a relative position of a first black matrix component with respect to first two corresponding sub-pixels located in a central region of said array is different from a relative position of a second black matrix component with respect to second two corresponding sub-pixels located in a peripheral region of the array.

### TECHNICAL FIELD

The present disclosure relates to display panels. Moreover, the present disclosure also relates to display apparatuses comprising such display panels.

### BACKGROUND

Display technologies have seen significant advancements in recent years, driven by an increasing demand for high-resolution and immersive visual experiences across various electronic devices. Presently, several display technologies such as Liquid Crystal Display (LCD) technology, Light-Emitting Diode (LED) display technology, and the like, are being used to make pixels of display panels. A conventional display panel made using one such display technology is described hereinbelow.

FIG. 1 (Prior Art) is a simplified sectional view of a pixel of a conventional display panel. Referring to FIG. 1 (Prior Art), illustrated is a simplified sectional view of a pixel 100 of a conventional display panel. The pixel 100 is, for example, made using LCD technology. The pixel 100 is shown to comprise three sub-pixels: a blue sub-pixel (B), a red sub-pixel (R), and a green sub-pixel (G). A plurality of black matrix components (depicted as black matrix components 102 having a solid black colour) are arranged on the conventional display panel such that each black matrix component forms a boundary between two corresponding sub-pixels. Furthermore, the pixel 100 comprises a backlight unit 104, thin-film transistors (TFTs) (depicted as hatched elements on the backlight unit 104, wherein TFTs that are ON are depicted as dotted hatched elements and TFTs that are OFF are depicted as checkerboard hatched elements) and a liquid crystal layer 106. In such a case, if the pixel 100 is observed from an angle (i.e., not observed from straight direction) light rays emanating from the red sub-pixel R (depicted as three dash-dot light rays) leak under the black matrix components 102 and undesirably get mixed with light rays emanating from the blue sub-pixel B (depicted as a dotted light ray) and the green sub-pixel G (depicted as a dashed light ray). Such light mixing may yield incorrect colours such as a magenta colour 108 formed by mixing of red colour ‘r’ and blue colour ‘b’, and a yellow colour 110 formed by mixing of the red colour ‘r’ and green colour ‘g’, along with correctly yielded red colour ‘r’ 112 along the straight direction from the red sub-pixel R.

Therefore, it is clear from FIG. 1 that conventional display panels have some drawbacks associated therewith. In case of observing pixels from an angle (and particularly, from steep angles), there is occurrence of light leakage between adjacent sub-pixels under black matrix components arranged between said adjacent sub-pixels, which leads to incorrect colourization in the conventional display panels. In other words, the light leakage causes colour shifting or uneven colour distortion, leading to reduced colour accuracy and image quality especially at edges and corners of the conventional display panel.

This problem with conventional display panels is more pronounced when such conventional display panels are used in compact optical assemblies such as those in head-mounted display devices, for example. In such optical assemblies, the conventional display panels are arranged close to one or more optical elements such that light emanating from the conventional display panels travels through such optical elements to reach a viewer's eye. For example, light rays from edges and corners of the conventional display panels may travel through a steeper angle as compared to light rays from central regions of the conventional display panels, which causes the aforesaid light leakage and colour shifting. This results in adversely impacting a visual experience of the viewer, and therefore some solutions are presently being developed to address this problem. For example, in some instances, a design of the one or more optical elements may be customized to tackle light leakage. In some other instances, the display panels are designed such that they produce images to be observed directly, without employing the one or more optical elements. In yet other instances, the light leakage and its resulting colour shift is measured to calculate a colour correction matrix, such that when the colour correction matrix is applied to an image which is to be displayed on the conventional display panel, the image as seen through the one or more optical element is relatively less colourized on edges and corners. None of these solutions are able to fully prevent the light leakage and/or colour shift, or to mitigate effects of the light leakage and/or the colour shift, and thus find very limited use.

Therefore, in light of the foregoing discussion, there exists a need to overcome the aforementioned drawbacks.

### SUMMARY

The aim of the present disclosure is to provide a display panel having a non-uniform black matrix and a display apparatus having such display panels, to provide a visual experience that is free from unwanted colour mixing and errors. The aim of the present disclosure is achieved by a display panel and a display apparatus as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 (Prior Art) illustrates a simplified sectional view of a pixel of a conventional display panel;

FIG. 2A illustrates an architecture of a display panel, in accordance with an embodiment of the present disclosure;

FIG. 2B illustrates regions of an array of pixels of the display panel of FIG. 2A, in accordance with an embodiment of the present disclosure;

FIG. 2C illustrates a given pixel in the display panel of FIG. 2A, in accordance with an embodiment of the present disclosure;

FIG. 2D illustrates an exemplary schematic illustration of the display panel of FIG. 2A, in accordance with an embodiment of the present disclosure;

FIG. 3 illustrates a simplified sectional view of a portion of a central region of the array of FIG. 2B, in accordance with an embodiment of the present disclosure;

FIG. 4 illustrates a simplified sectional view of a portion of a peripheral region of the array of FIG. 2B, in accordance with an embodiment of the present disclosure;

FIG. 5 illustrates a side view of a given sub-pixel in the display panel of FIG. 2A, in accordance with an embodiment of the present disclosure; and

FIGS. 6A and 6B illustrate schematic illustrations of a display apparatus, in accordance with different embodiments of the present disclosure.

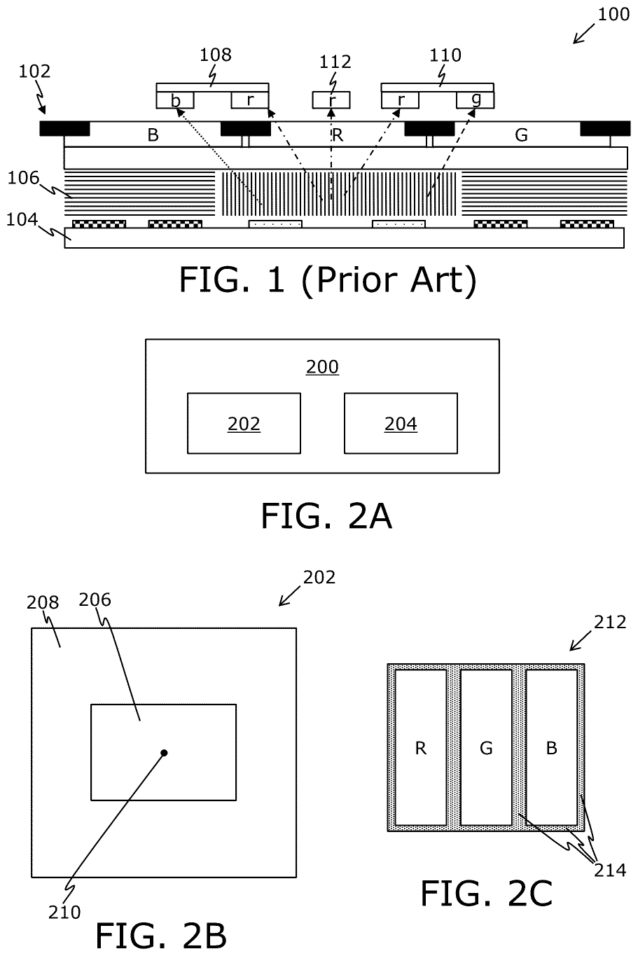

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a display panel comprising:
an array of pixels, each pixel comprising at least three sub-pixels; and
a black matrix comprising a plurality of black matrix components, each black matrix component being arranged to form a boundary between two corresponding sub-pixels;
wherein a relative position of a first black matrix component with respect to first two corresponding sub-pixels located in a central region of said array is different from a relative position of a second black matrix component with respect to second two corresponding sub-pixels located in a peripheral region of said array.

The present disclosure provides the aforementioned display panel. In the display panel, the black matrix is non-uniform (i.e., the plurality of black matrix components are arranged differently with respect to sub-pixels in the array of pixels, for the central and peripheral regions of the array), which beneficially prevents light leakage across said sub-pixels in a non-uniform manner. The black matrix is customized to differently position black matrix components over their corresponding sub-pixels by taking into account that light emanated by sub-pixels in the central region and sub-pixels in the peripheral region follow different optical paths. This provides maximum-feasible effective apertures of said sub-pixels along with providing the light leakage prevention for sub-pixels located in various regions of the array. Resultantly, this minimizes colour distortion (i.e., unwanted colour mixing or colourization) and inaccuracies in the display panel, especially for sub-pixels located towards edges and corners of the display panel. This customization also optimizes a distribution of light and colour across the display panel for enhancing image quality and colour accuracy across the display panel. Overall, the display panel described herein provides a high-quality visual experience. The display panel can be manufactured easily, and be used in various display devices.

In a second aspect, the present disclosure provides a display apparatus comprising:
at least one display panel according to any of the preceding claims; and at least one optical element per eye arranged on an optical path of the at least one display panel.

The present disclosure provides the aforementioned display apparatus. The display apparatus employs the custom-designed display panels (described in the first aspect) in the display apparatus, along with the at least one optical element, to synergistically produce a technical effect of presenting colour-correct and perspective-correct images to a viewer. In this regard, the light emanating from the display panel follows an optimized and tightly-controlled optical path, through the at least one optical element, towards the viewer's eyes. Even when the at least one display panel and the at least one optical element are arranged close to each other, light rays travelling through steep angles (such as light rays from edges and/or corners of the at least one display panel) do not mix unwantedly with other light rays (travelling through relatively gradual angles), and colour mixing is effectively prevented in the display apparatus. The at least one display panel is designed such that it enables a compact design of the display apparatus, which eventually improves ergonomics of the display apparatus.

Throughout the present disclosure, the term “display panel” refers to a display or a screen that is capable of displaying images. In operation, the display panel displays the images.

It will be appreciated that the array of pixels in the display panel could be implemented as a one-dimensional array of pixels or a two-dimensional array of pixels. The pixels (of said array) are arranged in a required manner (for example, such as a rectangular two-dimensional grid, a polygonal arrangement, a circular arrangement, an elliptical arrangement, a freeform arrangement, and the like) on the display panel.

Furthermore, the pixels of the array can be made using any well-known display technology, for example, such as Liquid Crystal Display (LCD) technology, Light-Emitting Diode (LED) display technology, an Organic LED (OLED) display technology, a micro OLED display technology, an Active Matrix OLED (AMOLED) display technology, a Liquid Crystal on Silicon (LCOS) display technology, or similar.

Throughout the present disclosure, the term “sub-pixel” refers to a separately addressable single-colour picture element. The at least three sub-pixels of each pixel correspond to at least three different colours. As an example, a given pixel may comprise three sub-pixels in a Red-Green-Blue (RGB) sub-pixel arrangement, wherein the given pixel comprises a red sub-pixel, a green sub-pixel, and a blue sub-pixel that are arranged in a one-dimensional array. As another example, the given pixel may comprise five sub-pixels in a Red-Red-Green-Green-Blue (RRGGB) sub-pixel arrangement, wherein the given pixel comprises two red sub-pixels, two green sub-pixels, and one blue sub-pixel that are arranged in a PenTile® matrix layout. It will be appreciated that the given pixel could include any suitable configuration of the at least three sub-pixels, for example such as a Red-Green-Blue-White (RGBW) sub-pixel arrangement, a Red-Green-Blue-Green (RGBG) sub-pixel arrangement, or similar. A non-uniform sub-pixel arrangement encompasses non-uniformity with respect to at least one of: a physical arrangement of sub-pixels in the array of pixels, a shape of the sub-pixels, a size of the sub-pixels, an orientation of the sub-pixels, and the like.

Optionally, the array of pixels in the display panel is implemented as the two-dimensional array of pixels. For example, in this regard, the display panel may be in the shape of a square, a rectangle, a rectangle with cut corners, or similar. It will be appreciated that a viewing angle of a viewer on the display panel is typically a cone-shaped viewing angle, so the viewer views round, elliptic, or similar, regions on the display panel. In other words, the central region may be circular, elliptical, or similar, and the peripheral region may be a remaining region of the display panel that surrounds the central region. The central region of the array of pixels includes and surrounds a centre of the array of pixels. Optionally, the central region of the array of pixels lies in range of 1-30 degrees from a surface normal of a centre of said array. In this regard, an angular width of the central region of said array lies in a range of 2-60 degrees. The peripheral region of the array of pixels surrounds the central region. Optionally, the peripheral region of the array of pixels lies in range of20-90 degrees from a surface normal of a centre of said array. In this regard, an angular width of the peripheral region of said array lies in a range of 40-180 degrees.

The “black matrix” of the display panel is a layer of black material that surrounds each sub-pixel on the display panel. The layer of black material has aperture(s) or hole(s) for each sub-pixel of the display panel. The black material beneficially has high light absorption, low reflectance, high durability, and compatibility with the display technology used for making the array of pixels on the display panel. The black matrix is made up of multiple black matrix components. The term “black matrix component” refers to any component of the black matrix that separates two adjacent sub-pixels such that said component is also visually arranged in between two adjacent sub-pixels). The black matrix component provides said separation by being arranged to form a boundary between the two adjacent sub-pixels. The black matrix component could be in the form of vertical lines and/or horizontal lines. The black matrix component could additionally or alternatively be in the form of oblique lines, for example, in the PenTile@ matrix layout. It will be appreciated that a given line of the black matrix component can be considered to have multiple parts, for example, such as one part covering one sub-pixel, another part covering another sub-pixel adjacent to the one sub-pixel, and yet another part covering an area between said sub-pixels.

It will be appreciated that for a given black matrix component, its given two corresponding sub-pixels are those two adjacent sub-pixels between which the given black matrix component is present. The term “given black matrix component” refers to at least one of: the first black matrix component, the second black matrix component. Correspondingly, the term “given two corresponding sub-pixels” refers to at least one of: the first two corresponding sub-pixels, the second two corresponding sub-pixels. A “relative position” of the given black matrix component with respect to given two corresponding sub-pixels is indicative of how the given black matrix component is arranged with respect to the given two corresponding sub-pixels. Said relative position impacts light leakage between the given two corresponding sub-pixels. Optionally, the relative position of the given black matrix component with respect to the given two corresponding sub-pixels is indicated by at least widths of parts of the given black matrix component that overlap with the given two corresponding sub-pixels.

Optionally, the different relative positions of the first black matrix component and the second black matrix component with respect to the first two corresponding sub-pixels and the second two corresponding sub-pixels, respectively, are determined based at least on a position of the display panel and a position of a viewer's eye, and optionally also on a position of any optical element that is arranged on an optical path between the display panel and the viewer's eye. Said positions may be fixed or variable, but they are pre-known, and thus the different relative positions can be accurately pre-determined based on said positions. A technical effect of the relative position of the first black matrix component with respect to the first two corresponding sub-pixels located in the central region of said array being different from the relative position of the second black matrix component with respect to the second two corresponding sub-pixels located in the peripheral region of said array is that it effectively minimizes unwanted light leakage (i.e., unwanted light cross-talk) between adjacent sub-pixels. The location of such adjacent sub-pixels impacts an optical path followed by light emitted therefrom. When black matrix components are uniquely positioned with respect to their corresponding sub-pixels, depending on a location of such sub-pixels within the array, the optical path is tightly controlled to prevent the light leakage from centrally-located sub-pixels as well as peripherally-located sub-pixels. As a result, unwanted colour mixing is also prevented. This enhances an overall viewing experience.

It will be appreciated that a physical structure of the display panel described herein is customized by implementing a unique non-uniform black matrix over a uniform sub-pixel arrangement or a non-uniform sub-pixel arrangement in the array of pixels, which provides non-uniform light leakage prevention across the display panel. The non-uniform black matrix provides non-uniform effective apertures of the sub-pixels in the display panel. As a result, the display panel can be used in compact optical assemblies without undesirable light leakage across sub-pixels, colour errors, geometric errors, and similar. In particular, said customization is implemented by the above-described sub-pixel location-based relative positioning of black matrix components with respect to their corresponding sub-pixels (of the pixels) of the array.

Optionally, in the central region of said array, a width of a part of the first black matrix component that overlaps with one of the first two corresponding sub-pixels is equal to a width of another part of the first black matrix component that overlaps with another of the first two corresponding sub-pixels. Such a relative position of the first black matrix component with respect to the first two corresponding sub-pixels enables light leakage prevention by the first black matrix component, for the first two corresponding sub-pixels. Since the first two corresponding sub-pixels lie in the central region of the array, light emanating therefrom would travel along an almost same optical path (for example, a straight optical path) to reach the viewer's eye. Therefore, a manner in which light leakage is to be prevented for both the first two corresponding sub-pixels is beneficially designed to be the same, by positioning the first black matrix component centrally and equally relative to the first two corresponding sub-pixels in the aforesaid manner.

Optionally, the width of the part of the first black matrix component and the width of the another part of the first black matrix component lies in a range of 0.05-0.5 micrometre. Other widths of the part and the another part, which lie outside the aforesaid range, may also be feasible. It will be appreciated that such widths may depend on one or more of a required resolution of the central region of the array, a size of a given sub-pixel, and the like. Furthermore, optionally, a length of a given black matrix component or its part lies in a range of 5-15 micrometres. It will be appreciated that dimensions of given black matrix component may depend on the display technology employed for making the display panel.

In some implementations, the width of the part of the first black matrix component and the width of the another part of the first black matrix component is same for all pairs of adjacent sub-pixels in the central region of the array. In other implementations, the width of the part of the first black matrix component and the width of the another part of the first black matrix component is different for different pairs of adjacent sub-pixels in the central region of the array, and depends on a location of a given pair of adjacent sub-pixels in the central region. For sub-pixels of a given pair of adjacent sub-pixels in the central region, the width of the aforesaid parts of the first black matrix component would always remain equal. Optionally, greater a distance between a centre of the array and the first two corresponding sub-pixels, lesser is the width of the part of the first black matrix component and the width of the another part of the first black matrix component. It will be appreciated that in such implementations, said widths are customizably set based on the location of the first two corresponding sub-pixels within the central region of the array, for enabling effective prevention of light leakage even for sub-pixels located near a boundary of the central region of the array.

Optionally, in the peripheral region of said array, a width of a part of the second black matrix component that overlaps with one of the second two corresponding sub-pixels is greater than a width of another part of the second black matrix component that overlaps with another of the second two corresponding sub-pixels, wherein a distance between a centre of the array of pixels and the one of the second two corresponding sub-pixels is shorter than a distance between the centre of the array of pixels and the another of the second two corresponding sub-pixels. Such a relative position of the second black matrix component with respect to the second two corresponding sub-pixels enables light leakage prevention by the first black matrix component, for the second two corresponding sub-pixels. Since the second two corresponding sub-pixels lie in the peripheral region of the array, light emanating therefrom would travel along different optical paths to reach the viewer's eye. In particular, the light emanating from the one of the second two corresponding sub-pixels (which is closer to the centre of the array of pixels, amongst the second two corresponding sub-pixels) would travel a shorter and less steeply-angled optical path as compared to the another of the second two corresponding sub-pixels. Therefore, a manner in which light leakage is to be prevented for both the second two corresponding sub-pixels is beneficially designed to be unequal, and dependent on their distance from the centre of the array of pixels, by positioning the second black matrix component relative to the second two corresponding sub-pixels in the aforesaid manner. The width of the part of the second black matrix component that overlaps with the one of the second two corresponding sub-pixels which is closer to the centre of the array of pixels designed to be higher, so that it effectively prevents unwanted mixing of light emanating from the another of the second two corresponding sub-pixels (which travels a relatively longer and more steeply-angled optical path) with light emanating from the one of the second two corresponding sub-pixels.

Optionally, the width of the part of the second black matrix component that overlaps with the one of the second two corresponding sub-pixels lies in a range of 0.025 micrometres-0.75 micrometres. Optionally, the width of the another part of the second black matrix component that overlaps with the another of the second two corresponding sub-pixels lies in a range of 0.75 micrometres-0.025 micrometres. It will be appreciated that such widths depend on a size of pixels, display panel and optics dimensions, and the like.

Optionally, the width of said part of the second black matrix component is pre-determined based on an observation angle of the second two corresponding sub-pixels. Similarly, optionally, the width of said another part of the second black matrix component is pre-determined based on the observation angle of the second two corresponding sub-pixels. It will be appreciated that the widths of both the aforesaid parts of the second black matrix component are determined and tuned together. The term “observation angle” refers to an angle formed between a direction of observation and a surface normal of a given sub-pixel. When the display panel is in use, the viewer's eye gazes along the direction of observation, to view a sub-region of the display panel which includes the second two corresponding sub-pixels. In this regard, the observation angle may be formed between the direction of observation and any sub-pixel amongst the second two corresponding sub-pixels. The direction of observation could be measured with respect to an optical centre of at least one optical element arranged on the optical path of the display panel. Optionally, larger the observation angle, larger is the width and/or an offset of said part of the second black matrix component, and vice versa. As the observation angle increases, the light emanating from the another of the second two corresponding sub-pixels travels through a relatively steeper angle towards the viewer's eye, and thus can mix with the light emanating from the one of the second two corresponding sub-pixels. Such mixing is unwanted as it leads to adverse colourization in the display panel. Employing larger widths of said part of the second black matrix component effectively prevents such mixing and mitigates the colourization caused by the light leakage under the second two corresponding sub-pixels, for providing an enhanced viewing experience.

Optionally, the width of said part of the second black matrix component is pre-determined further based on a height of a given sub-pixel. The “height” of the given sub-pixel refers to a total height of multiple layers that form the given sub-pixel. Light emanating from the given sub-pixel travels through these multiple layers, so the height of the given sub-pixel (and additionally optionally, a height of individual layers amongst the multiple layers) influences light mixing between the given sub-pixel and its adjacent sub-pixels. In particular, the height of the given sub-pixel affects transmission of the light emanating from the given sub-pixel across the given sub-pixel and its adjacent sub-pixels. So, the height of the given sub-pixel can be utilized along with the observation angle, to accurately pre-determine how much said light would leak into a given adjacent sub-pixel of the given pixel. An extent of said leakage may be determined as a leakage area on an active area (i.e., an aperture) of the given adjacent sub-pixel, and therefore a width of a part of the second black matrix component that overlaps with the given adjacent sub-pixel may be determined accordingly, to cover the leakage area. Upon such overlap, an effective active area (i.e., an effective aperture) of the given adjacent sub-pixel is provided, which is equal to the (original) active area minus the leakage area.

When the given sub-pixel is the another of the second two corresponding sub-pixels and the width of said part of the second black matrix component is determined based on the observation angle and the height of the given sub-pixel, it beneficially ensures that the width of said part of the second black matrix component is optimally-sized for preventing light leakage between the second two corresponding sub-pixels and for providing a well-illuminated and visual detailed viewing experience. In particular, it is ensured that the width of said part of the second black matrix component is large enough to cover a potential leakage area on an active area of the one of the second two corresponding sub-pixels to prevent light leakage whilst also being small enough to provide a sufficiently-large effective active area of the one of the second two corresponding sub-pixels.

It will be appreciated that the height of each sub-pixel of the array is typically the same. Optionally, the height of the given sub-pixel lies in a range of 20 nanometres-1 millimetres. The height of the given sub-pixel can also be any other value lying outside the aforesaid range. It will be appreciated that the height of the given sub-pixel depends on the display technology used for making the pixels of the array. For example, when the pixels of the array are made using LCD technology, the multiple layers of an LCD sub-pixel may comprise: a backlight, a first substrate and a second substrate, a liquid crystal (LC) layer encased between the first substrate and the second substrate, a first electrode deposited on the first substrate and disposed between the LC layer and the first substrate, a second electrode deposited on the second substrate and disposed between the LC layer and the second substrate, and a colour filter. The first electrode could be a pixel electrode for enabling individual control of the LCD sub-pixel, while the second electrode could be a common electrode that is connected to an electrical ground. Furthermore, a location and an aperture size of the colour filter is pre-known, which enables in correctly customising the display panel. Optionally, a height of the LC layer lies in a range of 2-12 micrometres.

It will be appreciated that there may be yet another part of the given black matrix component that does not overlap with either of the given two corresponding sub-pixels. A width of said yet another part of the given black matrix component may or may not be equal to the aforesaid width of any part of the given black matrix component that overlaps with any of the given two corresponding sub-pixels. For example, the width of the yet another part of the given black matrix component lies in a range of 0.01-0.5 micrometres.

The present disclosure also relates to the display apparatus as described above. Various embodiments and variants disclosed above, with respect to the aforementioned display panel, apply mutatis mutandis to the display apparatus.

Throughout the present disclosure, the term “display apparatus” refers to specialized equipment that is configured to present an extended-reality (XR) environment to the user when the display apparatus in operation is worn by the user on his/her head. In such an instance, the display apparatus acts as a head-mounted device (for example, such as an XR headset, a pair of XR glasses, and the like) that is operable to present a scene of the XR environment to the viewer. Commonly, the “display apparatus” may be referred to as “head-mounted display (HMD) device”. Throughout the present disclosure, the term “extended-reality” encompasses virtual reality (VR), augmented reality (AR), mixed reality (MR), and the like.

It will be appreciated that the display apparatus comprises the at least one display panel, for mimicking binocular vision of humans to provide enhanced depth perception. In some implementations, the at least one display panel comprises a single display panel, wherein the single display panel is shared between both eyes such that one portion of the single display panel is used to display one image for a left eye and the other portion of the single display panel is used to display another image for a right eye. In other implementations, the at least one display panel comprises (i.e., encompasses) a plurality of display panels, wherein one or more display panels are employed per eye. In such implementations, the one or more display panels for a given eye are used to display a given image for the given eye. The at least one display panel beneficially leverage stereoscopy to present slightly different images to each eye, for enhancing the depth perception. In this way, the display apparatus provides an immersive and realistic viewing experience for the viewer (i.e., a user of the display apparatus). Optionally, the images displayed on the at least one display panel are XR images.

The at least one optical element per eye is arranged on the optical path of the at least one display panel (i.e., an optical path between the at least one display panel and the viewer's eye, along which light emanating from the at least one display panel travels). When the display apparatus is in use, the viewer's eye views the images presented on the at least one display panel, through the at least one optical element. Optionally, the at least one optical element is implemented as at least one of: a lens, a prism, a light-guiding optical component. The light-guiding optical component could be an optically-transparent waveguide.

It will be appreciated that the at least one optical element has an optical property associated therewith, so passage of the light emanating from the at least one display panel therethrough impacts the visual experience of the viewer. Within the display apparatus, the at least one display panel and the at least one optical element are arranged at pre-known positions and have pre-known orientations, due to which said impact of the at least one optical element can be accurately calculated. Optionally, a distance between the at least one display panel and the at least one optical element lies in a range of 1-60 millimetres. For example, when the at least one optical element comprises a pancake lens, said distance could lie in a range of 1-2 millimetres. This means that the display apparatus beneficially has a compact design. A technical effect of employing custom-designed display panels (described in the first aspect) in the display apparatus, along with the at least one optical element is that they synergistically present colour-correct and perspective-correct images to the viewer. The custom-design of the at least one display panel is implemented by taking into account the position of the at least one display panel, as well as the distance between the at least one display panel and the at least one optical element, so that light leakage can be effectively prevented even when light rays travel along variably-angled optical paths resulting from the compact design of the display apparatus. It will also be appreciated that a position from which the viewer's eye would view its corresponding image(s) displayed on its corresponding display panel(s) is also pre-known (from manufacturing information of the display apparatus). Therefore, from said position, observation angles for each pair of adjacent sub-pixels in the array of pixels (of the at least one display panel) can also be mathematically determined accurately. Optionally taking the observation angles into account when customising the at least one display panel beneficially enables tight control of the optical path of the light emanating from each sub-pixel of the at least one display panel, for mitigating light leakage and providing a high-quality viewing experience.

### DETAILED DESCRIPTION OF THE DRAWINGS

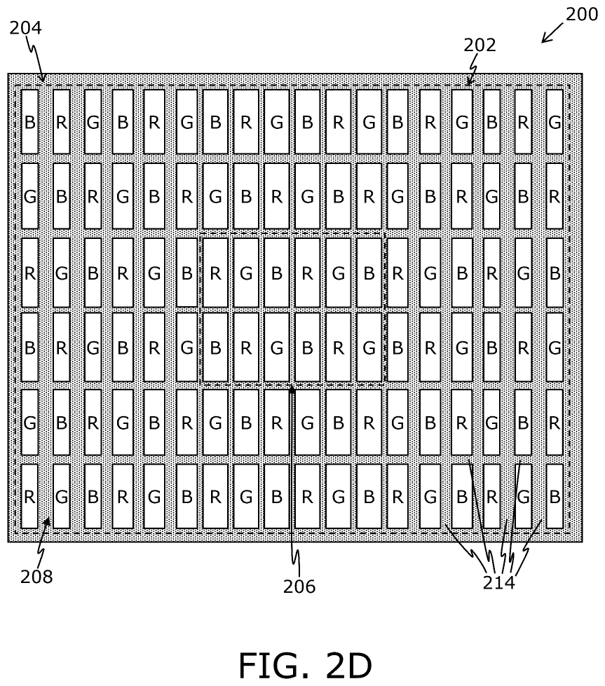

Referring to FIG. 2A, illustrated is an architecture of a display panel 200, in accordance with an embodiment of the present disclosure. The display panel 200 comprises an array 202 of pixels, and a black matrix 204. Each pixel of the array 202 comprises at least three sub-pixels. The black matrix 204 comprises a plurality of black matrix components, each black matrix component being arranged to form a boundary between two corresponding sub-pixels. A relative position of a first black matrix component with respect to first two corresponding sub-pixels located in a central region of said array 202 is different from a relative position of a second black matrix component with respect to second two corresponding sub-pixels located in a peripheral region of said array 202.

Referring to FIG. 2B, illustrated are regions of the array 202 of pixels of the display panel 200 of FIG. 2A, in accordance with an embodiment of the present disclosure. The array 202 has a central region 206 and a peripheral region 208, wherein the central region 206 of the array 202 is surrounded by the peripheral region 208 of the array 202. The peripheral region 208 is the remaining region of the array 202 excluding the central region 206. A centre 210 of the array 202 of pixels is also shown.

Referring to FIG. 2C, illustrated is a given pixel 212 in the display panel 200 of FIG. 2A, in accordance with an embodiment of the present disclosure. The given pixel 212 comprises at least three sub-pixels (depicted for example, as a red sub-pixel (R), a green sub-pixel (G), and a blue sub-pixel (B)). There are also shown black matrix components 214 (depicted as a dense dotted hatch pattern), each black matrix component being arranged to form a boundary between two corresponding sub-pixels. The black matrix components that are shown are in the form of vertical lines and horizontal lines.

Referring to FIG. 2D, illustrated is an exemplary schematic illustration of the display panel 200 of FIG. 2A, in accordance with an embodiment of the present disclosure. As shown, the display panel 200 comprises the array 202 of pixels, and the black matrix 204 (depicted as a dense dotted hatch pattern). Each pixel of the array 202 comprises at least three sub-pixels (depicted for example, as a red sub-pixel (R), a green sub-pixel (G), and a blue sub-pixel (B)). The central region 206 of the array 202 is surrounded by the peripheral region 208 of the array 202. The peripheral region 208 is the remaining region of the array 202 excluding the central region 206. The black matrix 204 comprises a plurality of black matrix components (depicted as black matrix components 214), each black matrix component being arranged to form a boundary between two corresponding sub-pixels. In the display panel 200, a relative position of a first black matrix component with respect to first two corresponding sub-pixels located in the central region 206 of said array 202 is different from a relative position of a second black matrix component with respect to second two corresponding sub-pixels located in the peripheral region 208 of said array 202.

It may be understood by a person skilled in the art that the FIGS. 2A, 2B, 2C and 2D includes simplified illustrations of the architecture of the display panel 200, the regions of the array 202, the given pixel 212 in the display panel 200, and the exemplary schematic illustration of the display panel 200, respectively for sake of clarity only, which should not unduly limit the scope of the claims herein. The person skilled in the art will recognize many variations, alternatives, and modifications of embodiments of the present disclosure. For example, the central region 206 as shown in FIGS. 2B and 2D may be circular, elliptical, or similar.

Referring to FIG. 3, illustrated is a simplified sectional view of a portion of the central region 206 of the array 202 of FIG. 2B, in accordance with an embodiment of the present disclosure. In the central region 206 of said array 202, a width w1 of a part of a first black matrix component 302 that overlaps with one of first two corresponding sub-pixels (depicted as sub-pixels 304A and 304B) is equal to a width w2 of another part of the first black matrix component 302 that overlaps with another of the first two corresponding sub-pixels 304A-B. There is also shown yet another part of the first black matrix component 302 that does not overlap with either of the first two corresponding sub-pixels 304A-B. The yet another part of the first black matrix component 302 has a width z and lies between the parts having the widths w1 and w2.

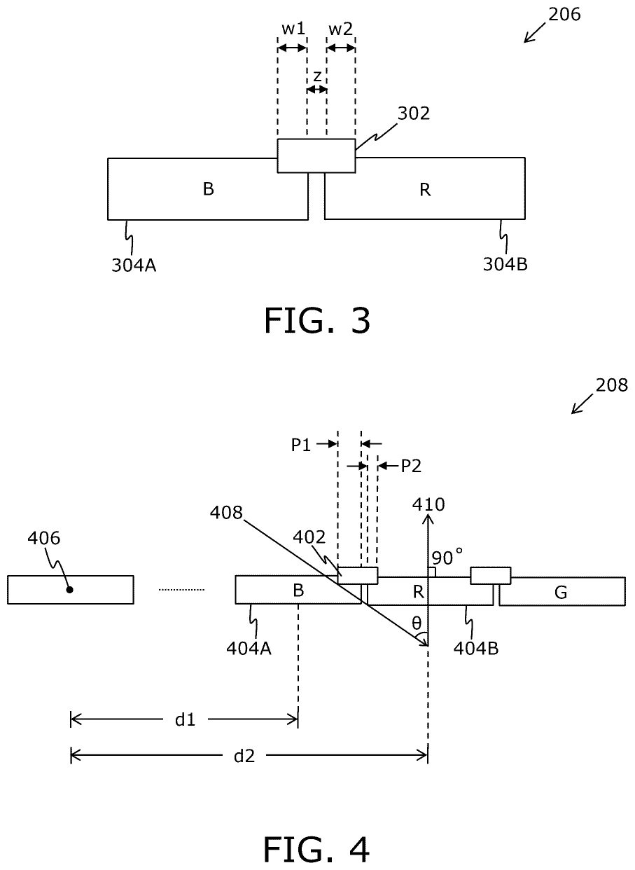

It may be understood by a person skilled in the art that the FIG. 3 includes a simplified sectional view of the portion of the central region 206 for sake of clarity, which should not unduly limit the scope of the claims herein. The person skilled in the art will recognize many variations, alternatives, and modifications of embodiments of the present disclosure. Referring to FIG. 4, illustrated is a simplified sectional view of a portion of the peripheral region 208 of the array 202 of FIG. 2B, in accordance with an embodiment of the present disclosure. A relative position of a second black matrix component 402 with respect to second two corresponding sub-pixels (depicted as second two corresponding sub-pixels 404A and 404B) located in the peripheral region 208 is different from a relative position of the first black matrix component 302 (of FIG. 3) with respect to the first two corresponding sub-pixels 304A-B (of FIG. 3) located in the central region 206 of the array 202.

In the peripheral region 208 of said array 202, a width P1 of a part of the second black matrix component 402 that overlaps with one (i.e., the sub-pixel 404A) of the second two corresponding sub-pixels 404A-B is greater than a width P2 of another part of the second black matrix component 402 that overlaps with another (i.e., the sub-pixel 404B) of the second two corresponding sub-pixels 404A-B, wherein a distance d1 between a centre 406 of the array 202 of pixels and the one (i.e., the sub-pixel 404A) of the second two corresponding sub-pixels 404A-B is shorter than a distance d2 between the centre 406 of the array 202 of pixels and the another (i.e., the sub-pixel 404B) of the second two corresponding sub-pixels 404A-B. Furthermore, the width P1 of said part of the second black matrix component 402 (i.e., the part that overlaps with the sub-pixel 404A) may be pre-determined based on an observation angle θ of the second two corresponding sub-pixels 404A-B. The observation angle θ is formed between a direction of observation 408 and a surface normal 410 of a given sub-pixel (such as the sub-pixel 404B).

It may be understood by a person skilled in the art that the FIG. 4 includes a simplified sectional view of the portion of the peripheral region 208 for sake of clarity, which should not unduly limit the scope of the claims herein. The person skilled in the art will recognize many variations, alternatives, and modifications of embodiments of the present disclosure. For example, the second two corresponding sub-pixels 404A-B are shown to lie on a right side of the centre 406. If another pair of sub-pixels lying on a left side of the centre 406 are considered, then a width distribution of black matrix components corresponding to the another pair of sub-pixels would visually appear to be opposite to that of the width distribution of the second black matrix component 402 that overlaps with the second two corresponding sub-pixels 404A-B.

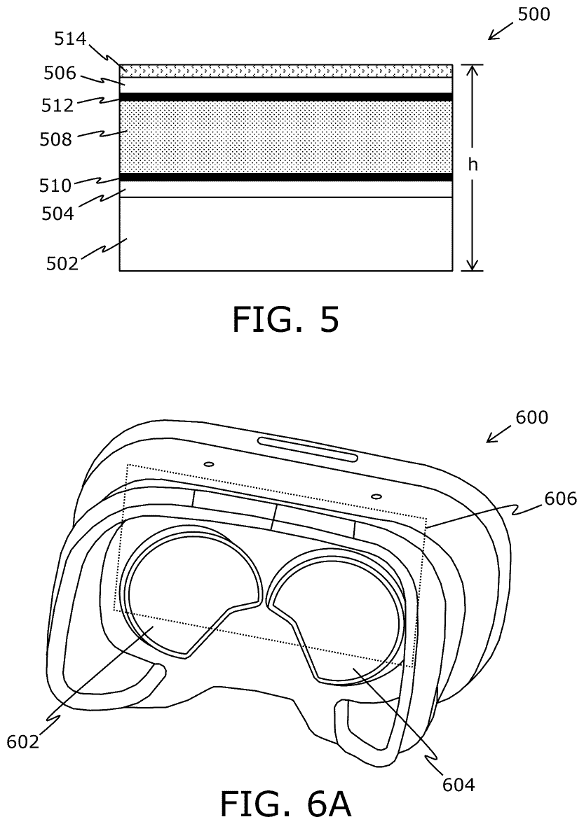

Referring to FIG. 5, illustrated is a side view of a given sub-pixel 500 in the display panel 200 of FIG. 2A, in accordance with an embodiment of the present disclosure. The given sub-pixel 500 could be located in the central region 206 and/or the peripheral region 208 of the array 202 of the display panel 200. A height h of the given sub-pixel 500 is a total height of multiple layers that form the given sub-pixel. Considering, for example, that the pixels of the array 202 are made using Liquid Crystal Display (LCD) technology, the multiple layers of the given sub-pixel 500 comprise a backlight 502, a first substrate 504 and a second substrate 506, a liquid crystal (LC) layer 508 encased between the first substrate 504 and the second substrate 506, a first electrode 510 deposited on the first substrate 504 and disposed between the LC layer 508 and the first substrate 504, a second electrode 512 deposited on the second substrate 506 and disposed between the LC layer 508 and the second substrate 506, and a colour filter 514.

It may be understood by a person skilled in the art that the FIG. 5 includes a simplified exemplary side view of the given pixel 500 for sake of clarity, which should not unduly limit the scope of the claims herein. The person skilled in the art will recognize many variations, alternatives, and modifications of embodiments of the present disclosure.

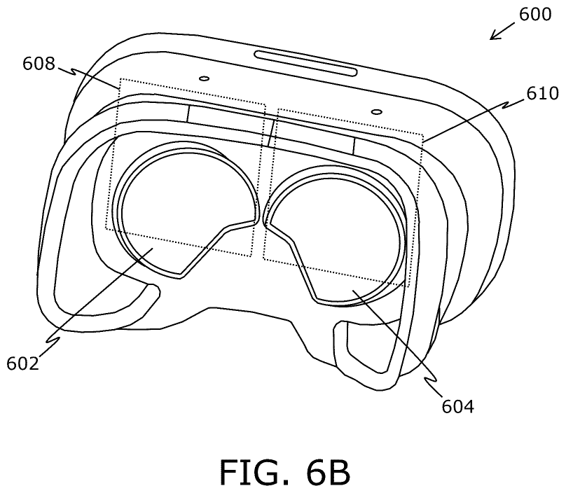

Referring to FIGS. 6A and 6B, illustrated are schematic illustrations of a display apparatus 600, in accordance with different embodiments of the present disclosure. The display apparatus 600 comprises at least one display panel and at least one optical element per eye (depicted as an optical element 602 for a first eye and an optical element 604 for a second eye in both FIGS. 6A and 6B) arranged on an optical path of the at least one display panel. In FIG. 6A, the at least one display panel is shown to comprise a single display panel 606 that is shared between the first eye and the second eye such that different portions of the single display panel 606 are used to display different images for different eyes. In FIG. 6B, the at least one display panel is shown to comprise a plurality of display panels (depicted as a display panel 608 for the first eye and a display panel 610 for the second eye).

It may be understood by a person skilled in the art that the FIGS. 6A and 6B include simplified schematic illustrations of the display apparatus 600 for sake of clarity, which should not unduly limit the scope of the claims herein. The person skilled in the art will recognize many variations, alternatives, and modifications of embodiments of the present disclosure. For example, the at least one optical element per eye could include a plurality of optical elements per eye, that are arranged at a plurality of positions within the display apparatus 600. Such optical elements could be of one or more types, such as lenses, prisms, any other light-guiding optical elements, or similar.

1. A display panel comprising:
an array of pixels, each pixel comprising at least three sub-pixels; and
a black matrix comprising a plurality of black matrix components, each black matrix component being arranged to form a boundary between two corresponding sub-pixels;
wherein a relative position of a first black matrix component with respect to first two corresponding sub-pixels located in a central region of said array is different from a relative position of a second black matrix component with respect to second two corresponding sub-pixels located in a peripheral region of said array,
wherein the relative positions are pre-determined based on both an observation angle and a height of the respective sub-pixels,
wherein the observation angle is determined from pre-known positions of the display panel and at least one optical element for presenting a scene to a viewer's eye, and
wherein the predetermination is configured to accurately pre-determine a leakage area of light from one sub-pixel to an adjacent sub-pixel, and determine the relative position of any included black matrix components to cover the leakage area to prevent light leakage.

2. The display panel of claim 1, wherein in the central region of said array, a width of a part of the first black matrix component that overlaps with one of the first two corresponding sub-pixels is equal to a width of another part of the first black matrix component that overlaps with another of the first two corresponding sub-pixels.

3. The display panel of claim 1, wherein in the peripheral region of said array, a width of a part of the second black matrix component that overlaps with one of the second two corresponding sub-pixels is greater than a width of another part of the second black matrix component that overlaps with another of the second two corresponding sub-pixels, wherein a distance between a centre of the array of pixels and the one of the second two corresponding sub-pixels is shorter than a distance between the centre of the array of pixels and the another of the second two corresponding sub-pixels.

4. The display panel of claim 3, wherein the width of said part of the second black matrix component is pre-determined based on an observation angle of the second two corresponding sub-pixels.

5. The display panel of claim 4, wherein the width of said part of the second black matrix component is pre-determined further based on a height of a given sub-pixel.

6. A display apparatus comprising:
at least one display panel according to claim 1; and
at least one optical element per eye arranged on an optical path of the at least one display panel.
